(19) United States
(12) Patent Application Publication
(10) Pub. No.: US 2023/0321853 A1
(43) Pub. Date: Oct. 12, 2023

(54) SAFETY RAZORS

(71) Applicant: INOTECH Kunststofftechnik GmbH, Nabburg (DE)

(72) Inventors: Michaela KOHUT, Hamburg (DE); Alexander KRÜMKE, Hamburg (DE); Martin WEHMANN, Norderstedt (DE); Josef GLEIXNER, Nabburg (DE); Sander PATJE, Zuidwolde (NL)

(73) Assignee: INOTECH Kunststofftechnik GmbH, Nabburg (DE)

(21) Appl. No.: 18/004,808

(22) PCT Filed: Jul. 5, 2021
(86) PCT No.: PCT/EP2021/068436

§ 371 Date: Jan. 9, 2023

(30) Foreign Application Priority Data
Jul. 10, 2020 (DE) 10 2020 118 272.4

(51) Int. Cl. B26B 21/52

(52) U.S. Cl. CPC B26B 21/522; B26B 21/528; B26B 21/521

(57) ABSTRACT

A safety razor handle with a chunky, non-elongate handle body comprising a core layer made of a plurality of sub-layers and an outer layer at least substantially covering the core layer.

### CROSS-REFERENCE TO RELATED APPLICATION

This application claims priority from German Pat. application No. DE 10 2020 118 272.4 filed Jul. 10, 2020, the disclosure of which is hereby incorporated herein in its entirety by reference.

### FIELD OF THE INVENTION

The invention generally relates to safety razors and, more particularly, to a handle for a safety razor.

### BACKGROUND

Safety razors are typically composed of a blade unit (or cartridge) connected, either detachably or fixedly (permanently fixed or integrated), to a handle. A safety razor with a detachable and disposable cartridge is known as a safety razor system. Cartridges are known which have one or more parallel blades perpendicular to the shaving direction and thus to the handle, each defining a cutting edge, with cartridge elements positioned in front of and behind (rear of) the cutting edge(s) (referred to as a “guard” and a “cap”, respectively) in a shaving direction. A shaving aid, such as a thin lubricating strip, or lubrapad is often incorporated into one or both of these cartridge elements to improve shaving performance and lubricating treatment of the user’s skin.

Typically, the handle is elongate extending essentially in the direction of shaving. It would be desirable to provide an improved shaving experience by design of the safety razor handle and also to provide a handle which is efficient to manufacture.

### SUMMARY

In one aspect, an embodiment of the invention provides a safety razor handle with a chunky, non-elongate handle body comprising a core layer made of a plurality of sub-layers and an outer layer at least substantially covering the core layer.

The combination of the core layer and outer layer allow a construction with advantageous user and/or production characteristics (such as an outer layer with a preferred user-feel and a core which is stable or lighter or cheaper or easier to mold in bulk). It also cuts down the “bulk” of the material used in each molding which requires cooling, so that the manufacture can be more efficient. This is particularly advantageous for a non-elongate handle. The sub-layers in the core enhance this advantageous effect. The sub-layers are thinner segments together making up the core. The use of thinner segments optimizes cooling during the manufacturing process. If the core were molded as one segment it might take a very long time to cool this large amount of plastic and problems with air traps and skin marks might occur. By manufacturing the core in sub-layers such problems are prevented and the cooling (which makes up a large amount of part price) is optimized.

In one embodiment, the sub-layers are created by sequential injection molding of one or more subsequent sub-layers on a first sub-layer. The sub-layers may be of the same or of a different material. Preferably they are of the same material. There may be between 2 and 6 sub-layers, for example 4-sublayers, depending on the size of the chunky handle and the material used for moulding.

In one embodiment, a first sub-layer extends in a flat round shape from a handle attachment portion. There may be intermediate layers (if there are more than two sub-layers). Any intermediate sub-layers may extend in a flat round shape to one side or the other of the first sub-layer. If the flat round shape is viewed as a plate, the intermediate sub-layers can stack like plates above and/or below the initial plate of the first sub-layer. Preferably, a first intermediate sub-layer is provided on an upper or lower main face of the first sub-layer, and possibly a second intermediate sub-layer is provided on an upper or lower main face of the first intermediate sub-layer. A final sub-layer may extend to at least partially surround the first sub-layer (and any intermediate sub-layers). The flat layers may cool more quickly than other layer shapes.

Preferably, each of the sub-layers (and the outer layer) takes the same amount of time to cool when molded (for example to within a tolerance margin of 10 to 30%, or preferably within 10% or within around 5 seconds). This balancing of the sub-layers allows process optimization, so that all the layers can be molded together in a process in which the layers are molded simultaneously (on different handle bodies). If one layer were to require 60 seconds and another 5 seconds, such a process would not be optimal and the cycle time would be extended to the longest cooling time for all the molding steps.

An interlocking connection may be provided between two sub-layers. For example, a protrusion on the top of one plate may fit into a recess on the bottom of a neighboring plate or vice versa. This aids stability of the body.

The thickness of the sub-layers may be at least substantially constant over the majority of their extent, for improved molding characteristics.

In one embodiment, the outer layer is of softer material and the core layer is of one or more harder materials. The two-layer, harder-inside and softer-outside construction gives stability as well as comfort of handling. Of course, the two layers may be of the same hardness or even of the same material.

Either or both of the outer and core layers may be partly or fully mixed with a perfume, a scent, a flavour, an aroma or a fragrance by impregnation, embedding or mixing. The perfume, scent, flavour, aroma or fragrance may be of natural or synthetic origin, and they may dissipate and/or evaporate from the handle during use in order to create an olfactory sensation with the user.

Preferably both layers are translucent. The combination of the two translucent layers (the combination of which is translucent too) is not only attractive but also practical in allowing parts behind the body to be glimpsed through the body and thus aiding user orientation and shaving performance. Moreover taken together, the harder-inner and softer-outer layers and translucency produce a surprisingly improved user experience.

In some embodiments, the borders between the sub-layers and preferably also the border between the core layer and the outer layer cannot be distinguished by the naked eye, or cannot be easily distinguished by the naked eye. This improves the overall translucency and user experience.

Translucent materials allow penetration of light (and include transparent materials). One standard method for haze and luminous transmittance of transparent plastics is defined by the standard ASTM D1003. The (different) translucent materials may both have a light transmission under this standard of over 70%, or 80% at 550 nm, preferably of over 85%. The materials may both have a haze of less than 20%, preferably less than 15%, more preferably less than 5%.

Hardness of the material may be measured on the Shore scale(s). The Shore hardness of the inner core material is usually higher than the Shore hardness of the outer layer, as mentioned above. Preferably the outer layer (or “skin”) may have a Shore A hardness of approximately 10 to 60, preferably 20 to 40 or around 30, to give a squeezable feel and pleasurable tactile sensation when gripped by the user. The inner core may have the same Shore A hardness as the outer layer or preferably a higher Shore A hardness (over 70), for example a Shore D hardness of over 30, over 50 or over 70.

In some embodiments the outer layer does not form a complete cover over the inner layer, enabling a design with partially hard and partially soft feel areas or different color options. In preferred embodiments, the outer layer forms a complete covering over the inner layer on the outer surface of the handle body. Thus wherever the user holds the handle body, the tactile impression is similar. The look and feel of the handle body is also improved.

In some embodiments, the core layer is thicker than the outer layer. For example, the core layer thickness in a cross section of the handle body may be at least three times, four times or five times, preferably between 5 and 20 times the outer layer thickness in the cross section of the handle body (in a usual construction, there will be two outer layer parts of approximately equal thickness when measuring thicknesses in a straight line crossing the center of the cross section, one to either side of a single or single-material core part). The thicker core and thinner outer can give a user the desirable combination of haptic feedback from the softer outer layer and stability from the harder core.

In some embodiments, the thickness of the outer layer is at least substantially constant over the majority of the core layer, or over substantially the whole core layer, for example with a thickness variation of less than 30%, preferably 20%, more preferably 10 % or 5% of the maximum layer thickness. This feature also allows an improved all-over tactile impression.

This substantially constant thickness of the outer layer may be between about 1 and 7 mm, preferably between about 3 and 5 mm, giving a sufficient covering for comfortable handling whilst retaining a more rigid core.

The core itself may be of an overall non-elongate, bulbous shape (essentially the same overall shape as the finished handle body as described later, if the outer layer is substantially of a fairly constant thickness).

The handle may include a handle connecting structure for a cartridge. In this case, the outer layer may include an opening leading to a recess in the core layer housing the handle connecting structure (or indeed in a simple embodiment, the recess itself may form the handle connecting structure).

The safety razor handle may further comprise a wet friction-enhancing finish (such as rough texturing or hydrophobic texturing or fluorising) on the outer layer, a friction-enhancing additive to the outer layer or a friction-enhancing surface coating on the outer layer. Increase of wet friction using any of these methods (or a combination of these methods) is particularly desirable, given the bathroom environment in which safety razors are used. A friction-enhancing surface coating in the form of a lacquer is a particularly suitable measure. Such a lacquer can additionally improve other properties, such as visual or haptic properties (to give color, texture, glossy effects or various tactile experiences, visual effects (pearlescence, metallic, splattered paint, etc.) or use properties (protection against any of UV radiation, chemical attack and mechanical rupture).

In some embodiments, the overall shape of the handle body is bulbous (“chunky” or “rotund”), in two orthogonal directions, widening away from an end surface towards the center of the body.

Such a handle body is surprisingly comfortable to hold and easy to maneuver, because it fits into the palm of the hand. It allows a firm grip but facilitates precise and flexible ergonomic handling, giving many varied gripping positions for the human hand and easy twisting of the handle within the grip to reach different angles. A chunky handle body may have a ratio of length in a direction orthogonal to the end surface to width in a direction parallel to the end surface of between 3 and one third, preferably between 2 and one half, more preferably between 1.5 and 0.75. The two orthogonal directions may be parallel to the end surface.

The handle body may comprise a further end surface opposite to the end surface. The two opposite surfaces may be connected by a convex side surface which widens (away from a central axis between the two opposite surfaces) towards the center (or approximate center) of the body to give the bulbous shape. The opposite further end surface gives an even better handling feel.

Of course, the handle body may widen away from the end surface not just in two orthogonal directions but in many or all of the directions in between these two orthogonal directions, so that the increase in size is general and thus of most of or the entire cross section. The side surface may be a single continuous curved side surface (for example linking the two end surfaces). This curved side surface, or a plurality of curved side surface portions, may provide the handle body with a cross section that increases continuously (without decreasing) away from the flat end surfaces towards the center of the body, forming the bulbous shape mentioned above. This can also give a good handling feel, with a flat face and possibly also an edge between the flat face and a curved face providing a tangible spatial reference to the user in combination with an easy-grip curved surface.

In use, the razor may be pulled across the skin in the shaving direction. The end surface may therefore be in front of the razor in the direction of shaving (to the rear of the cartridge if the cartridge is seen as at the front), and the further end surface behind the cartridge in the shaving direction (to the front of the razor).

Thus, the further end surface may be a front end surface. This surface thus forms the front of the razor in use, facing in the opposite direction to a direction of shaving. Correspondingly, the end surface may be a rear end surface facing in the shaving direction in use. The handle connecting structure may be on the (underneath) side surface, for example closer to the front end surface than to the rear end surface, for ease of use.

As mentioned above, one or both end surfaces may be flat. The flat end surfaces may be parallel, providing a symmetrical feel which gives the user a better tactile impression of the overall handle, for improved shaving experience. One or both of the flat end surface(s) may be circular or elliptical, for example.

In one embodiment, the handle body is in the form of a slanted barrel shape, with a skewed barrel surface between two end (front and rear) surfaces. The barrel shape may be terminated at either end with a slanted end surface, in that it is not orthogonal to the barrel axis. Neither is the barrel shape itself necessarily formed from a circle of varying diameter extruded along a central straight axis. Rather, the handle body as a whole may be viewed as having a skewed barrel shape (potentially with a curved barrel axis).

When the two parallel end surfaces are in a vertical orientation, with the attachment extending downwards, the barrel surface may be skewed/slanted upwards from the front end surface towards the rear end surface.

If the handle connecting structure projects from the side surface and parallel to the end surface, then a slanted/overhang design of the handle (with the end surface(s) extending at a slant (non-perpendicular angle) to the average direction of the side surface between the centres of the two end surfaces) allows the handle body to sit with the rear end surface at the back of the user’s hand grip on or towards the palm of the hand, with the user’s fingers positioned on the front end surface and side surface. In this position the end surfaces slope up and back towards the user’s hand, allowing a better view of and through the razor.

The barrel shape may have a substantially circular or substantially elliptical cross section perpendicular to its longitudinal axis (which may be straight or curved). The barrel shape may widen continuously from the two end surfaces towards the center.

The handle body is not elongate. For example, the largest diameter of the barrel shape (which may be central along its axis) may be between a third and three times the length of the longitudinal axis of the barrel, preferably between a half and twice. The largest diameter of the barrel shape may be larger than the length of its longitudinal axis.

The handle body may comprise an underneath surface portion facing the skin of the user in use and comprising the handle connecting structure for attachment to a blade unit; a front surface portion facing in the opposite direction from the shaving direction in use; a rear surface portion facing in the shaving direction in use; a top surface portion and (lateral) side surface portions, one directed to either side of the blade length (or side of the handle body) in use; wherein the top surface portion, underneath surface portion and side surface portions together form a continuous smooth surface which is a substantially cylindrical or substantially ellipsoid or substantially partially spherical surface. The distance between the front surface portion and rear surface portion may be between one third and three times, preferably between a half and twice, the largest dimension of the largest cross section through the continuous smooth surface.

The combination of the chunky shape designed to fit into the palm as variously defined above, with the translucency and softer-outer and harder-inner layered construction of the handle gives a particularly desirable user feel and shaving experience.

The handle body may have a substantially flat end surface and a side surface; and a cartridge attached to the side surface, wherein: when the flat end surface is in contact with a horizontal plane, the razor is in a stable position of rest, the flat end surface forming the razor’s only region of contact with the plane and elevating the cartridge above the plane. This shape allows the handle to stand on a surface with the blade and any lubrapad of an attached cartridge suspended above the surface. This can help prevent blade corrosion and adhesion of the shaving aid (lubrapad) to the surface.

The flat end surface allows the handle to stand on a horizontal plane, such as a basin edge or shelf with the blades and any shaving aid (e.g., lubrapad) of an attached cartridge suspended above the surface and no other point of contact between the safety razor and the horizontal plane. This can help prevent blade corrosion and adhesion of the shaving aid to the surface.

The term “flat” is used herein to describe a surface which is completely or substantially flat and which thus may include some portions which are not flat (and thus some portions which are not in contact with the horizontal plane). For example, the surface may include patterns, a logo, an opening or writing recessed into the flat surface, some surface texturing or curvature or the like. However, the surface may be substantially unbroken. Preferably over 80%, or more preferably over 90% of the surface is in contact with the horizontal plane.

The term “stable position of rest” indicates that the safety razor will stay in the upright position on its flat end surface with the cartridge elevated without any external assistance/force.

The flat end surface may be of a size which gives good stability to the safety razor when resting on a plane. Thus it may have an area which is larger than the footprint of the cartridge on the skin surface, or preferably an area which is twice or more this size.

As will be appreciated, the handle body need not be elongate. For example, the largest extent of the handle body (measured in any direction) may be up to twice the smallest dimension of the flat end surface. In one example, the distance between two parallel flat end surfaces is equal to or smaller than the diameter (or smallest dimension) of one or both flat end surfaces.

In one exemplary construction, the centre of mass of the handle and cartridge is above and vertically within the footprint of the flat end surface on the horizontal plane, and the handle body overhangs the flat end surface to one side when the razor is stably positioned on the flat end surface. This overhang side is preferably the side on which the cartridge is mounted. The cartridge may be mounted closer to the further flat end surface than to the flat end surface (i.e. closer to the front of the razor than to the rear in use, and closer to the top of the razor when stably positioned on the plane). Various different angles of overhang are possible.

The stability of the safety razor on the horizontal plane can be assured in any suitable way. The material of the handle body on the same side of the center of mass as the overhang may be less dense than the material of the handle body to the other side of the center of mass from the overhang. For example, there may be a hollowed portion extending in the overhang side, or a lower density material.

Equally, the flat end surface may be provided with an anti-tilting lip on the same side as the overhang. The anti-tilting lip may extend from the end surface on the overhang side.

Any suitable means may be provided to aid stability of the safety razor. For example, the flat end surface may be provided with a suction feature, such as an air opening into a hollow part in a flexible handle body to help retention of contact between the flat end surface and the horizontal plane.

Equally, the flat end surface may be provided with a recess or other interface allowing attachment to another part, such as packaging or a travelling case, or suspension from a hook (which could be provided separately) on a wall or other vertical surface (or the same air opening could be usable for both purposes).

The front surface portion may be flat or concave. This front surface may extend to the guard side of the attachment to the blade unit, and may conveniently be provided with a logo and/or instructions. It may extend substantially parallel to the rear surface portion and preferably substantially parallel to a main direction (in terms of longest extent) of the handle connecting structure (which is also referred to as a stem). The front and/or rear surface portions may extend at a slant to the continuous smooth surface (i.e. at a non-perpendicular angle). The top surface portion (and underneath surface portion) of the handle may be approximately parallel to the shaving plane in use. In this case, the front and/or rear surface portions extend at a slant to the user’s skin. The slant may be back away from the cap, giving improved visibility.

The recess for the handle connecting structure may be provided in the underneath surface portion of the handle body. For example, the handle connecting structure may fit, either permanently or detachably, into an insert housed in the recess, or directly into the recess. The recess may be of essentially rectangular cross-section, with a direction up into the handle, and may be at the same slant as the front and/or rear surfaces.

Another embodiment provides a safety razor (or safety razor system), comprising: a safety razor handle according to any of the definitions above; connected to a (replaceable) cartridge via the handle connecting structure.

A further aspect provides an embodiment relating to a method of manufacturing a chunky, non-elongate handle body of a safety razor handle comprising sequentially moulding a plurality of sub-layers of a core layer and then moulding an outer layer at least substantially covering the core layer. This is the method of production of the handle as variously described above, with all the attendant advantages.

In one embodiment, the handle body is injection molded using an injection molding apparatus with a rotating hub. The rotating hub may hold the handle bodies during molding. The hub may rotate, to rotate the bodies and index them between molding positions in the apparatus, each position including a cavity which adds a sub-layer or layer to the handle body.

The finished handle body may be ejected at an ejection position of the injection molding apparatus. In one preferred embodiment, there are six positions and a first sub-layer is molded in a cavity at a first position, an intermediate sub-layer is molded in a cavity at a second position, a further intermediate sub-layer is molded in a cavity at a third position, a final sub-layer is molded at a cavity in a fourth position and a thin outer skin is molded at a fifth position, with the handle body being ejected at a sixth position.

Advantageously, material is injected into all the cavities (and the finished handle body is ejected) at the same time. In this way, each index of the hub ejects another finished handle body and adds a layer to 5 unfinished handle bodies.

In this case the cavities may be constructed so that each of the sub-layers and the outer layer takes the same amount of time to cool, for example within a tolerance margin of around 10 to 30%, preferably around or under 10% or 5 seconds. This optimises the use of the cooling time in the cycle. Put in terms of the layers themselves, each of the sub-layers and the outer layer may have the same cooling time when injection molded.

The above indicated definitions, aspects and embodiments refer to the same handle shape and its manufacture and thus may be combined with each other (if not obviously mutually exclusive) to achieve the advantageous effects as described above. Further embodiments, features, and advantages of the invention, as well as the structure and operation of the various embodiments of the invention are described in detail below with reference to the accompanying drawings.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

Reference will now be made to FIGS. 1 to 17, in which:

FIG. 1 is a rendered side view of a safety razor in a use position;

FIG. 2 is a rendered front view of the safety razor shown in FIG. 1 in a use position;

FIG. 3 is a rendered perspective view from the side of the safety razor shown in FIG. 1;

FIG. 4 is a rendered perspective view from directly underneath of the safety razor shown in FIG. 1;

FIG. 5 is a rendered front perspective views from above of the safety razor shown in FIG. 1;

FIG. 6 is a side view of a safety razor standing upright on its flat end surface on a horizontal plane;

FIGS. 7a to 7d are sectional views through a razor demonstrating different thicknesses of the outer layer;

FIG. 8 is a photograph in side view of a safety razor with a different connection mechanism in a use position;

FIGS. 9a to 9d show the safety razor of FIGS. 1 or 8 with preferable dimensions in millimetres;

FIG. 10 is a perspective in-use view of a handle and cartridge with a lubrapad from the top side (user side);

FIG. 11 is a side view of the handle and cartridge with lubrapad of FIG. 10;

FIG. 12 is another perspective view of the handle, blade unit and lubrapad of FIG. 10, but from the front;

FIG. 13 is rendered perspective view of the handle and cartridge of FIG. 10;

FIG. 14 is a build diagram showing the sub-layers and outer skin and their layer-by-layer construction;

FIG. 15 is a cross section through a handle body and a handle connecting structure before insertion into the handle body;

FIG. 16 is a simplified diagram of a rotating-hub injection moulding apparatus; and

FIGS. 17(a) to (k)show different razor shapes and their use.

### DETAILED DESCRIPTION OF THE INVENTION

The following detailed description refers to the accompanying drawings that illustrate examples and embodiments consistent with this invention. Other embodiments are possible, and modifications can be made to the embodiments within the spirit and scope of the invention. Therefore, the detailed description is not meant to limit the invention.

The term “underneath” is used to describe features of the handle, cartridge or a lubrapad that are positioned on the skin-contacting side of the cartridge or lubrapad (i.e., on a shaving-side or underneath of the handle, cartridge or lubrapad) in use, and the term “top” is used to describe features of the handle, cartridge or lubrapad that are positioned on a side opposite the skin-contacting side of the cartridge or lubrapad in use (i.e., on a user side or on top of the cartridge or lubrapad). The terms “front”, “rear”, and “side(s)” are used herein with reference to the shaving direction, i.e., the direction in which the cartridge and lubrapad are intended to be moved during shaving. In particular, the term “front” means facing in the shaving direction, “rear” means facing in the opposite direction to the shaving direction, and “side(s)” mean to either side in the shaving direction. In general, the cartridge is positioned at the front of the razor in use and the razor is pulled backwards across the skin (with the cartridge last).

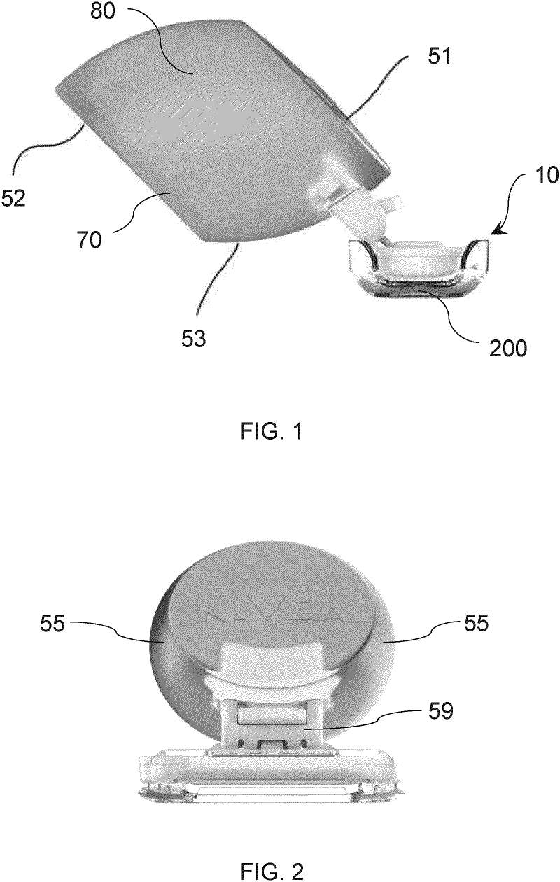

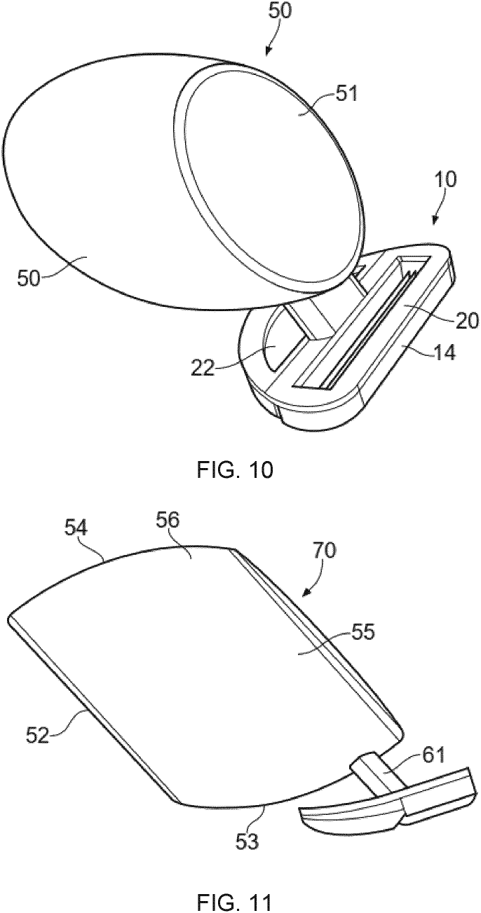

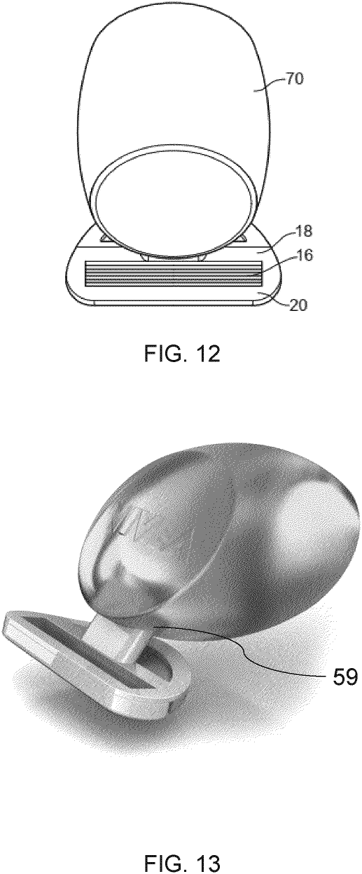

FIGS. 1 to 9 show different views of a safety razor of one embodiment in the form of a handle body 50 of rounded, chunky design attached to a cartridge 10 via a stem 59, 61 and are used to illustrate the handle shape before discussing the layers and sub-layers that make up the handle body in more detail. FIGS. 10 to 13 show a different embodiment.

The handle includes the handle body 50 and a handle stem or handle connecting structure 59.

The handle body in this example is made up of a multi-layered hard plastic core 80 and outer layer or skin 70. The soft skin is made from a translucent silicone or TPE (TPE-Versaflex CL30 from Polyone in this example). The material is translucent and light coloured, so light can easily transmit through it. The translucent material is not only attractive but also practical in allowing parts behind the body to be glimpsed through the body and thus aiding user orientation and shaving performance. The surface looks and feels silky and non-sticky to the hands of the user. The core is made of hard plastic such as styrene butadiene copolymer (in this example SBC -KR03-Resin from INEOS Styrosolution). Due to the chemical properties of these materials it is almost impossible to visually distinguish the border between hard core and soft skin and the borders between the sub-layers in the final product. The thickness of the outer layer is around 4 mm in this embodiment. FIGS. 1 to 5 also reveals the extension of the handle stem 59 into the body. The stem and any other interface part may be made of a harder plastic, such as SBC, PPA/PPS/LCP or ABS.

The handle body is formed by either LSR or injection or compression molded as explained in more detail later. The full razor weighs around 40 to 60 grams, preferably around 55 grams and the outer skin has a Shore A hardness of around 30, to give a squeezable feel and pleasurable tactile sensation when gripped by the user. It may include a logo on the front surface (the further end surface which is on the top when the razor is in the upright position). The inner core has a higher Shore A hardness (over 70), for example a Shore D hardness of 63.

When the razor is in use, the flat end surface 52 forms the rear surface of the razor, as shown in FIG. 1. The handle connecting structure 59, shown here connected to cartridge 10, extends from underneath surface portion 53. The cartridge is provided with a protective cover 200, which is removed for use.

Opposite to the flat end surface is a further flat end surface 51. This is a front surface portion when the razor is in use, as shown in FIGS. 1 to 5, and in an upright resting position is at the top. Any of the surfaces of the handle body, but particularly the front surface in use may be provided with information, logos, or other signs and patterns. Such a logo, for example, may have a different surface texture (gloss or matt or rough, for example) from the surrounding material, be protruded or recessed from the surrounding material or have a combination of finish and relief. If the handle body is made from more than one material, the combination of materials (for example using cut-outs or embossing) may be used to distinguish the logo.

These two opposite surfaces are parallel, and are separated by a single continuous side surface 56. As can be seen clearly from FIGS. 1 to 6, this side surface is approximately barrel-shaped and bulbous, with a chunky form that expands from the end surfaces towards the centre of the handle body. The barrel shape is terminated at either end with a slanted end surface, which is not orthogonal to the barrel axis. Neither is the barrel shape itself formed from a circle of varying diameter extruded along a central straight axis. Rather, the handle body as a whole may be viewed as having a skewed barrel shape (with a curved barrel axis). The skewed barrel shape gives a visual effect, for example, of a deformed barrel shape which is produced when a flexible, “jelly” material attached on its circular barrel end surface to a horizontal supporting plane is skewed laterally and parallel to the end surface by movement of the top (or further end) surface.

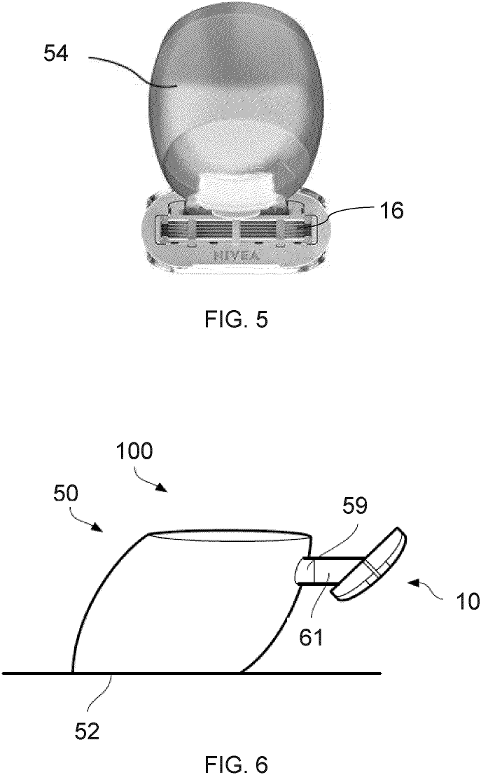

In use, the side surface of the handle body 56 has a curved underneath portion 53 as shown in FIG. 4, a curved top portion 54 as shown in FIG. 5 and curved lateral portions 55 as shown in FIG. 2. A handle stem 59 extends from the curved underneath portion of the handle body parallel to the end surfaces. The curved surface portions together form a continuous smooth curved surface which is substantially circular or ellipsoid in cross section, but may vary in shape and size along its length between the front and rear of the handle.

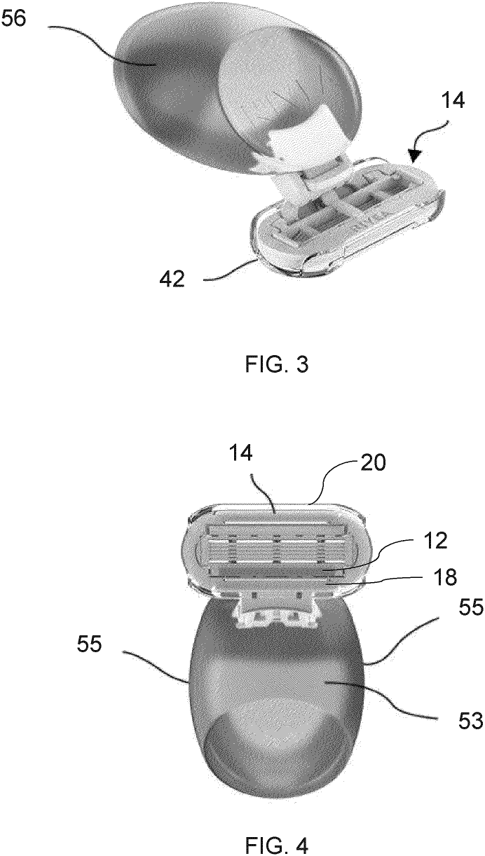

As shown best in FIGS. 3 to 5, the cartridge 10 includes a guard 18, a cap 20, and rounded side portions 42 that together define a blade housing 14 within which a plurality of blades 16 are disposed. The number of blades 16 can be, for example, four or five, though it can be fewer or more than this. The guard 18 is in front of the blades 16 in the shaving direction and the cap 20 is to the rear of the blades 16. The cartridge 10 can be connected to the handle body 50, either fixedly or detachably by connection between the handle stem 59 and a cartridge stem 61 (see FIG. 6). For example, cooperating means (not shown) on the handle stem and cartridge stem may provide a clipped, spring-loaded connection which can be unclipped using a moving part (shown as a protruding lever in FIGS. 1 to 5) which is contacted by the user to attach and/or detach the handle body and cartridge.

FIGS. 3 to 5 show the cartridge footprint on the user’s skin, with its parallel sides and rounded edges to each end of the blades. The area of the footprint can be measured by projecting the skin-contacting edges of the cartridge onto a flat plane.

The handle body has a flat end surface 52 on which it can rest stably upright on a (substantially) horizontal surface, as shown in FIG. 1. In this orientation, the flat end surface rests on the horizontal plane and thus forms an underneath surface, and the further end surface forms a top surface of the razor. Here, the in-use definitions of directions set out for the general case above do not apply. When the handle body is upright in its position of rest on a plane, the attachment means 59 which is provided on the side surface of the handle body towards the top surface is elevated above the plane. This elevates the cartridge itself above the plane, since the lowest point of the cartridge (the guard) is only slightly below the attachment means.

FIG. 6 shows a join between the handle connecting structure 59 and cartridge connecting structure 61 which is clearly visible as a simple line between the two parts, in contrast to the more complex structure of FIGS. 1 to 5, in which a lever is provided and the cartridge connecting structure in front view is mostly concealed by the handle connecting structure.

The handle stem may be fixedly connected to the handle body, such as by chemical connection.

The cartridge of these figures includes a lubricating strip or lubrapad 12 as an additional or integral part of the cartridge, for example with a single frame both surrounding the blades and providing a back support for the lubrapad. The end surface has been shown and described as flat, but may alternatively be curved or uneven, if there is no requirement for the razor to be stable in an upright position.

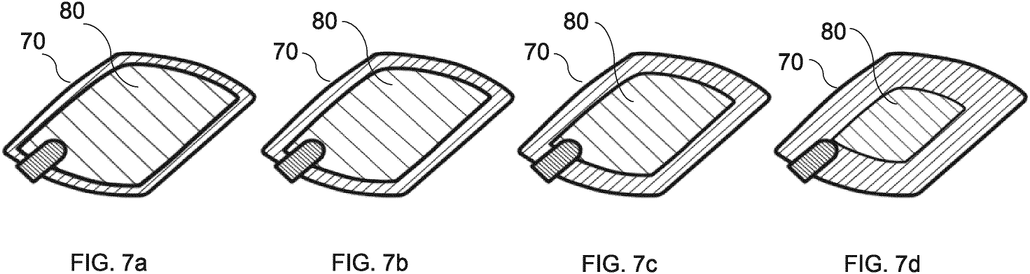

FIGS. 7a to 7d show a handle of the same external size but with different possible thicknesses of the outer skin (and thus different core sizes). For simplicity, the core sub-layers are not depicted. FIG. 7a shows the thinnest skin and FIG. 7d the thickest skin. FIGS. 7b or 7a corresponds to the exemplary thickness of skin in FIGS. 1 to 6.

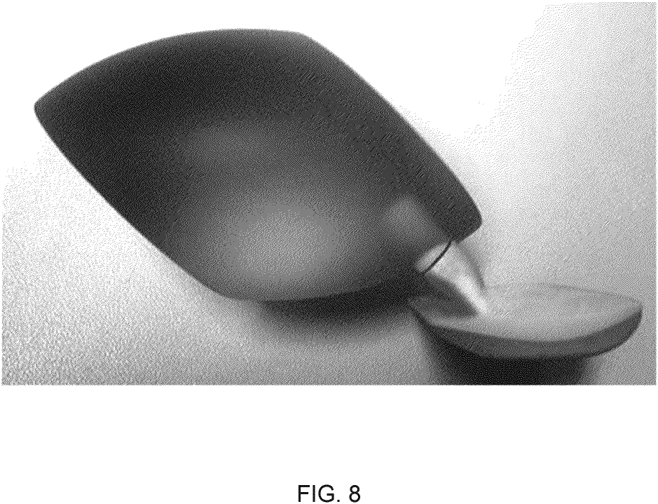

FIG. 8 shows a rendered view of a razor having a translucent handle body of the same construction as FIGS. 1 to 5 with a simpler attachment between the cartridge and handle body.

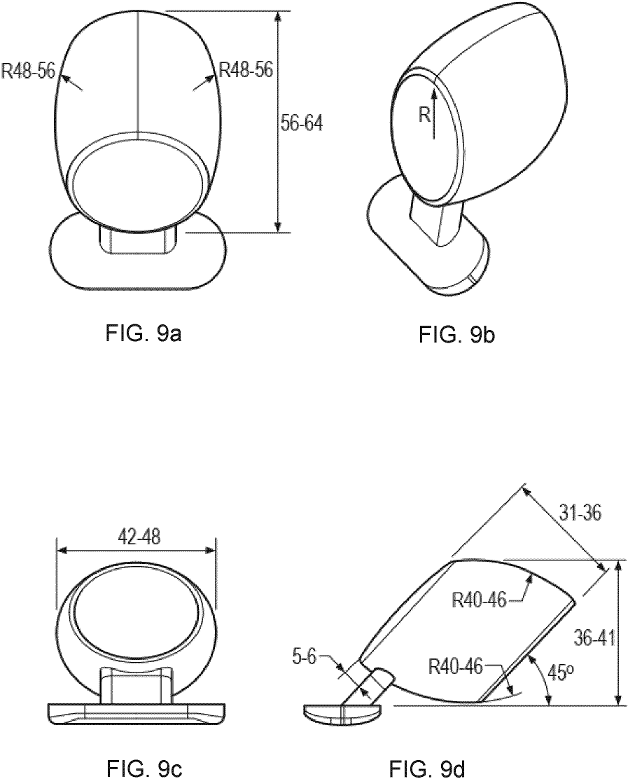

Some advantageous dimensions of the safety razor which give good maneuverability in the human hand are shown in FIGS. 9a, 9b, 9c and 9d. The maximum radius of curvature of the “skewed barrel shape” side surface may range between 35 and 75 mm, preferably 48 and 56 mm, for example 53 mm. The radius of curvature of the skewed barrel shape at the barrel ends is between 30 and 55 mm, preferably between 40 and 46 mm, for example 44 mm. The radius of the flat surfaces (measured along the surfaces, rather than perpendicular to the barrel surface) is slightly smaller.

The maximum length of the handle body parallel to the skin surface in use (with the end surface at 45° to the skin surface) is from 40 to 80 mm, preferably between 56 and 64 mm, for example 61 mm. This is measured from the foremost extent of the front (the lowest portion of the front or further end surface) to the rearmost extent of the rear (the highest portion of the rear or end surface which rests on the horizontal plane when the razor is upright). The maximum height of the handle body in use is between 25 and 55 mm, preferably between 36 and 41 mm, for example 39 mm.

The distance between the end surfaces is between 25 and 45 mm, preferably between 31 and 36 mm, for example 35 mm. The handle stem (or other interface between the handle and cartridge) starts at 3 to 10, preferably 5 to 6 mm along the underneath portion of the side surface in use from the front surface. The maximum width of the handle body measured parallel to the end surfaces is between 35 and 60 mm, preferably between 42 and 48 mm, for example 46 mm.

If the cartridge is flat on the skin in use, the end surfaces extend at between 35 to 55, preferably at 45 degrees to the skin surface.

The cartridge footprint may have a length of around 25-60 mm in the blade direction, preferably around 40-50 mm and a depth orthogonal to the blade direction from the front to the rear of the cartridge of around 10-30 mm, preferably 15-23 mm. Whilst the cartridge size may have a natural maximum linked to its function, the handle body and in particular the handle body extent in the blade direction is not similarly limited.

FIGS. 10 to 13 show slightly different cartridge construction, but the same general handle body shape, with like reference numerals labelling the same parts as for FIGS. 1 to 9. Therefore, the reader is directed to the previous description thereof. Again, the layered construction is not visible.

FIGS. 10 to 13 show lubrapad 12, and blades 16 in the blade housing 14. The cartridge 10 of these figures includes the lubrapad 12 as an integral part, with a single frame 26 surrounding the blades 16 and providing a back support for the lubrapad 12.

The safety razor handle comprises (as before) an underneath surface portion 53 facing the skin of the user in use and comprising a connecting structure (such as a stem 61) for attachment to a blade unit; a front surface portion 51 facing in the opposite direction from the shaving direction in use; a rear surface portion 52 facing in the shaving direction in use; a top surface portion 54 and lateral surface portions 55, one directed to either side of the blade length in use; wherein the top surface portion, underneath surface portion and side surface portions together form a continuous smooth surface which is a substantially cylindrical or substantially ellipsoid or substantially partially spherical surface. The distance between the front surface portion and rear surface portion is between one third and three times, preferably between a half and twice, the largest dimension of the largest cross section through the continuous smooth surface.

The term substantially cylindrical or substantially ellipsoid or substantially partially spherical surface is used to describe a shape which is close to cylindrical or ellipsoid or partially spherical form, for example with a 10% deviation from one of those forms. In one measure, a section (or all sections) taken vertically through the continuous smooth surface (for example in a direction parallel to the blade length) overlaps with a circle or ellipse drawn to just cover the whole section with the areas of the circle or ellipse which are not covered by the section being up to one tenth of the area of the section.

The front and rear surface portions may be flat or concave. The front surface may extend to the guard side of the attachment to the blade unit, and may conveniently be provided with a logo and/or instructions. It may extend substantially parallel to the rear surface portion and preferably substantially parallel to a main direction (in terms of longest extent) of the stem.

FIG. 13 shows a safety razor with the cartridge construction of FIGS. 10 to 12 and a non-flat “dished” (gently concave) front surface with an embossed logo.

In one razor embodiment, the handle connecting structure for attachment to the blade unit and corresponding structure on the blade unit/cartridge allow relative movement, such as pivoting movement, between the handle and the blade unit. For example the connection may have some play, or one or both of the attachment means or corresponding means may be flexible.

In this embodiment the safety razor comprises a lubrapad with a lubrapad body 22 adjacent to the blade unit, and extending along a guard of the blade unit and in front of the guard in use. The lubrapad body 22 has a greatest width and/or depth in the blade direction at the guard, the body width and/or depth reducing in a smooth convex curve away from the guard to a curved front portion of the body.

In a further definition of the handle shown in all these Figures, invention embodiments provide a safety razor handle wherein the body has a shape which is rounded and chunky (or bulbous), extending with perpendicular length I, width w and height h, wherein none of the maximum length, width and height of the body is more than 2, 3 or 4 times the size of the maximum in the other two dimensions.

For example, the height may be the largest vertical cross section through the side smooth surface previously defined, the width may be the largest horizontal cross section through the side surface and the length may be the horizontal distance (parallel with the shaving plane) between the end surfaces.

Any of the previous features of the handle and safety razor (and safety razor system) may be applied to these embodiments.

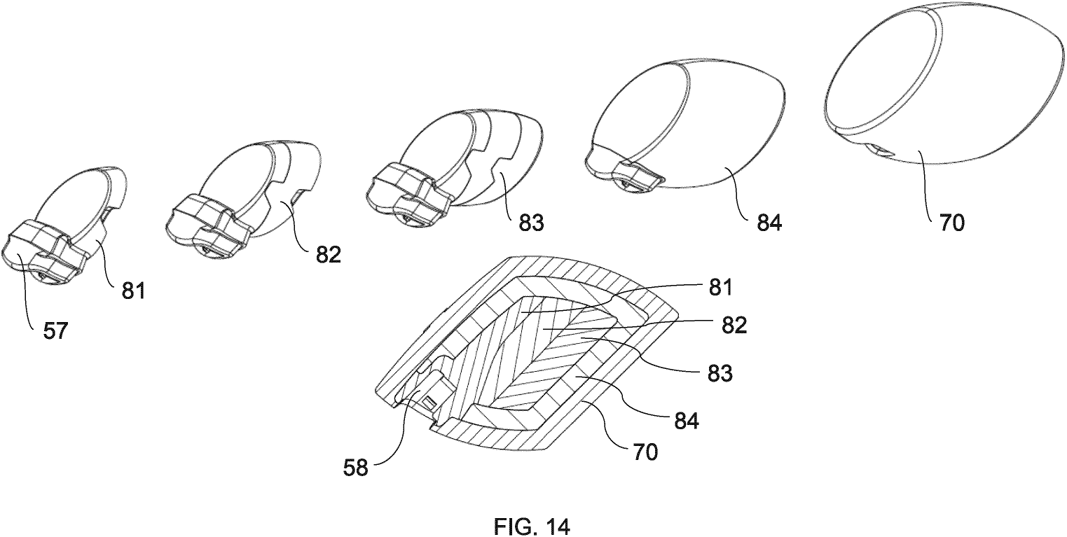

FIG. 14 provides perspective views of the build-up of the handle body layers by injection molding and the completed handle body. The handle body is fabricated in stages using sub-layers making up the core: in this case four sub-layers of the harder material and a single layer of the skin material. This sub-layering in multiple stages is to optimize the cooling during the molding process. If the hard core were molded as one segment it would take a very long time to cool the large amount (bulk) of plastic and problems with air traps and skin marks might occur. By molding the core in four stages, these problems are prevented and the cooling (which adds significantly to the part price) is optimized. After molding it is impossible to visually distinguish the borders between the four segments of the hard core. In a fifth stage the soft skin is molded around the hard core. Here four stages are shown to mold the core, but the use of at least two stages is already advantageous, and more than four stages might be provided. In any case, the build-up of sub-layers allows the layers to cool more quickly and reduces cycle time and thus costs.

The first layer 81 includes the handle attachment area surrounding the recess 58 and a generally flat round “plate” shape extending from this area. The intermediate sub-layers have a purely plate-like shape. The intermediate sub-layers can stack like plates above and/or below the initial plate of the first sub-layer. The second layer 82 is of a plate shape and is added below the first plate shape, with some interlocking for better connection. The third layer 83 is also a plate shape. The fourth layer 84 surrounds all the previous layers to give a smooth outer for the skin, with fewer joins. The fifth layer provides the final skin. Each of these sub-layers and the outer layer are designed to have the same cooling time, within a tolerance margin of for example 5 seconds, so that the cooling part of the cycle time (which is constrained as the cooling time which is the longest for all the layers) is used efficiently.

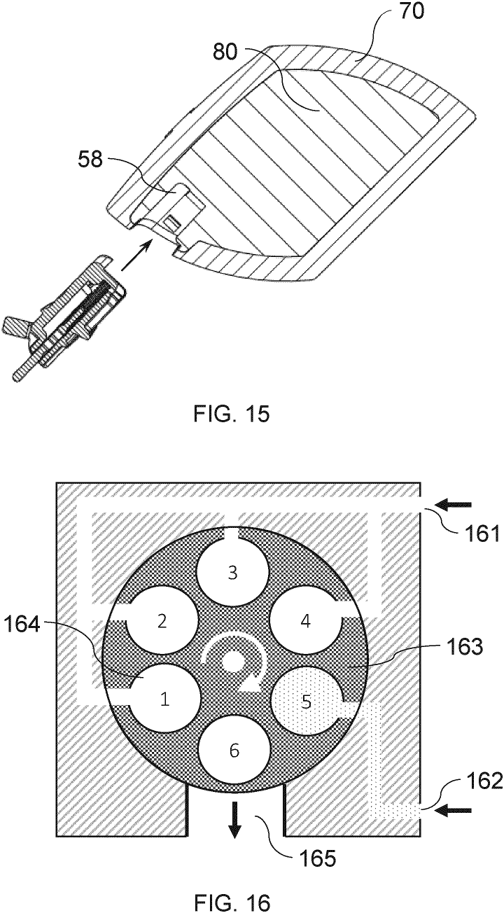

FIG. 15 shows a safety razor handle as previously described, before insertion of a handle connecting structure 59 into recess 58. The recess has snap details (undercuts) in order to snap the handle connecting structure into it. The core layer and outer layer are visible, but the sub-layers are not depicted, for simplicity.

FIG. 16 is a simplified diagram of an injection molding apparatus for molding the chunky, non-elongate handle body of a safety razor handle. It sequentially moulds four sub-layers of a core layer and then molds an outer layer to cover the core layer, finally ejecting a finished handle body.

The injection molding apparatus has a rotating hub (or core) 163 holding the handle bodies during molding in cavities 164. The hub rotates the bodies to index them between molding positions in the apparatus shown as 1, 2, 3, 4 and 5. Each position includes a cavity which adds a sub-layer or layer to the handle body. Advantageously, a single core material inlet 161 supplies positions, 1, 2, 3 and 4 with the molten material for the core sub-layers. Thus in this embodiment all the sub-layers are made of the same material. An outer layer material inlet 162 simultaneously supplies the cavity at position 5 with material for the outer layer (skin). The finished handle body is ejected at ejection position 6 via ejection chute 165 of the injection molding apparatus.

In more detail, a first sub-layer is molded in a cavity at 1, an intermediate sub-layer is moulded at 2, a further intermediate sub-layer is molded at 3, a final sub-layer is molded at 4 and a thin outer skin is molded at 5, with the handle body being ejected at 6.

As will be apparent, material is injected into all the cavities (and the finished handle body is ejected) at the same time. In this way, each 60 degree index of the hub ejects another finished handle body and adds a layer to five unfinished handle bodies, one at each molding position. When the mold is closed, plastic is injected into all the cavities simultaneously. In parallel, the finished handle is ejected from the mold. After injection, the plastic is cooled in the mold for about 50 seconds before the tool opens to rotate the hub. When the mold is opened again, the hub can rotate. The hub carries the unfinished handle bodies in a spoke arrangement extending radially outwards, each body attached to a spoke of the hub. When one injection has just taken place and the finished handle body has been ejected, it leaves a bare spoke in the ejection position 6, and the build-up of layers at positions 1 to 5.

Viewing the overall process for a single handle body, the cavity in position 1 is structured such that the molten core material forms the first core sub-layer 81. Following a first injection of molten hard core material and the passing of a period of time to allow the mould and the sub-layer to cool, the rotating/indexing hub opens and rotates 60° in a clockwise direction, so that that first sub-layer now occupies cavity at position 2. Similarly, the five other spokes will have rotated through 60° to occupy the next indexed position.

The cavity at position 2 is structured such that molten hard core material injected through core material inlet 161 reaches the cavity at position 2 and forms the second core sublayer 82 to one side of the first core sublayer 81.

The cooling, rotation, and injection of molten material proceeds a further 2 times, forming the third and fourth core sublayers 83, 84 in the same manner as previously described, except that for the fourth sub-layer, the molten material surrounds all the previous sub-layers, rather than being formed to one side.

The next cooling, rotating, and injection of molten material step takes the part-finished handle body into the cavity at position 5, into which molten soft material is injected to form the skin 70, surrounding the fourth core sublayer.

Upon a further cooling, and rotating, the handle body comprising all four sublayers and outer layer 70 is ejected from cavity position 6 through the finished product ejection chute 165.

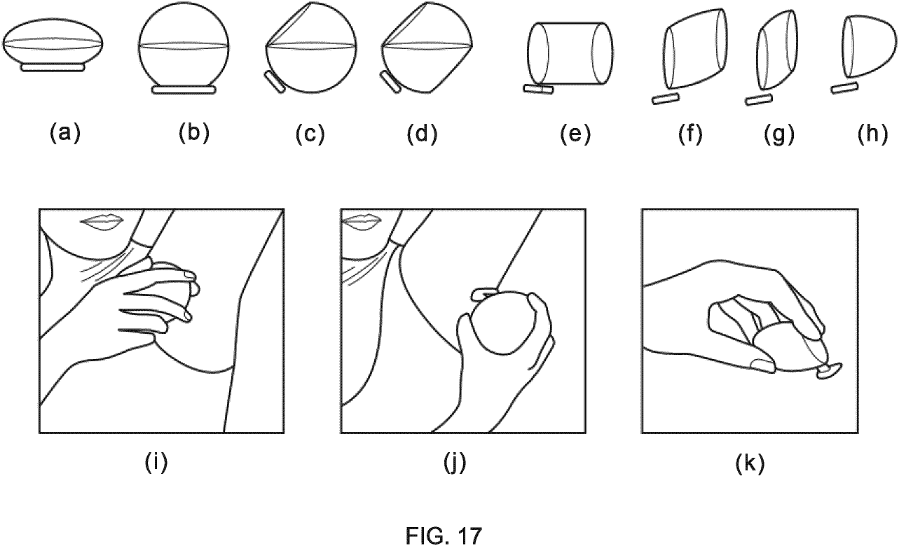

FIGS. 17(a) to (k) show different razor shapes and their use. FIG. 17a shows a cut-off elliptical cross-section handle body, with the cartridge attached to the underneath side in use, preferably off-center at the cut-off, approximately perpendicular to the vertical rotation axis.

FIG. 17b shows a cut-off spherical handle body with a cartridge attached to it off-center at the cut-off in the sense that the assumed stem direction is not parallel to the radius direction.

FIG. 17c shows a part-spherical handle body with a cut-off plane orthogonal to the axis connecting the centre of the plane to the center of the handle body, with a cartridge attached off-center to the part-spherical surface.

FIG. 17d shows a part spherical handle body with two parallel cut-off planes, each orthogonal to the axis connecting the center of the plane to the center of the handle body, with a cartridge attached off-center to the part-spherical surface.

FIG. 17e shows a cylindrical handle body with a cartridge attachable to one side towards the end of the handle body.

FIGS. 17f and 17g show different proportions of the skewed barrel shape previously described, with a longer barrel axis and a shorter barrel axis.

FIG. 17h shows a handle body with a front flat surface and continuously curved side and rear portion, with the safety razor attached to the curved side portion.

FIGS. 17i, 17j, and 17k show a safety razor in use, demonstrating how its chunky form fits well into the human hand.

### Materials

In any of the handle definitions, the handle body may comprise an outer molded translucent or transparent layer of elastomeric material such as silicone, polyurethane as TPU (thermoplastic polyurethane), PU (Polyurethane), TPE (thermoplastic elastomer), PETG (Polyethylene Terephthalate Glycol), TPS or rubber (such as liquid silicone rubber or compression silicone rubber) for example having a Shore A hardness of around 5 to 80, preferably a squeezable 30 Shore A under the ASTM D2240-00 testing standard. As used herein, TPEs are thermoplastic elastomers, for example thermoplastic elastomers selected from the group of styrenic block copolymers (TPE-s including TPE SBS and the hydrogenated version of TPE-SEBS; e.g. Thermoplast K, Thermolast M, Sofprene, or Laprene), thermoplastic olefins (TPE-o; e.g. For-Tec E), elastomeric alloys (TPE-v or TPV; e.g. Thermolast A, Thermolast V, Hipex, Forprene, Termoton-V, or Vegaprene), thermoplastic polyurethanes (TPU; e.g. Copec), thermoplastic copolyesters (TPE-E), thermoplastic polyamides and mixtures thereof. A preferred material is TPE-Versaflex CL30 from Polyone. As used herein, silicones (or polysiloxanes) are polymers that include any inert, synthetic compound made up of repeating units of siloxane.

These materials give a superior tactile feeling with a material that is soft and yet strong due to the shape of the handle. Moreover, the body being translucent or even transparent allows the user to gain a better feel of the positioning of the handle (and thus of the attached blade unit) with respect to the hand and to the skin to be shaved.

In any of the handle definitions, the core may be fabricated in transparent or opaque i.e. virgin or recycled polyethylene terephthalate, polycarbonate, polystyrene, styrene-acrylonitrile, Acrylonitrile-ButadieneStyrene (ABS), or polymethyl methacrylate or SBC (Styrene Butadiene Copolymer). A preferred material is SBC - KR03-Resin from Styrosolution. Some examples of materials for the handle connecting structure are PPA Polyphthalamide)/PPS (Polyphenylene sulphide)/LCP (Liquid Crystal Polymer). The material may have a glass filling of 0% up to 40%, or 10% to 30%, preferably around 20%. The materials and/or fabrication process may be chosen in such a way that the insert and core material will chemically bond with the handle material.

Measures may be taken to enhance the friction properties of the handle body, particularly to improve “wet grip”. To combine desired features such as transparency, softness and manufacturability, certain materials are chosen. When used in a wet environment during shaving, e.g. combined with soap, these materials may result in a very slippery feeling for the user. Significant improvements in wet grip may be achieved with the methods set out below (separately or in combination) whilst retaining (at least to a great extent) desirable initial properties of the material in terms of soft feeling and transparency.

By applying a rough texture to the outside of the handle, the wet grip can be improved. When there is no texture or a very fine texture, a thin layer of water can form between the handle and the human skin, the water cannot drain properly and therefore acts as a lubricant resulting in poor wet grip. If a rougher texture (RA, average roughness, estimated between 80 to 400 µm) is applied (based on the same design principle as the indentations in tires) the water can drain through the depressions/slots formed by the texture while the elevations/bumps (rubber islands in the tires) keep contact with the human skin.

Fine texturing can be hydrophobic and is a good alternative to rough texturing. Water droplets on a smooth surface will form an almost hemispherical shape. A surface given a fine (e.g. nano or pico) structure will form water droplets of increased height which are closer to spherical in shape. As a result the water will roll off the handle more easily and is less likely to form a thin layer of water which could give a slippery effect when gripped.

Wet friction may be increased with additives. For example, micro beads, with a maximum particle size in the tens or hundreds of microns may be suitable to increase friction. Other suitable additives may be petrolatum, polybutene, polyisobutylene or microcrystalline wax, or the like. The additives may be hydrophobic or oleophobic or work by another mechanism. Example commercially available additives are Styroflex (Ineos) or similar, Hybrar (Kuraray) or similar, Kraton FG 1901, organomodified siloxanes or any combination thereof.

Fluorising may also improve wet grip. In this process, the outer layer is treated with fluorine. Exposure to a fluorine mixture (for example gas-phase fluorising) allows replacement of some of the hydrogen atoms in the surface of the coating with fluorine.

Surface coatings may be of a softer plastic, harder plastic or other type of film. A friction-enhancing surface coating in the form of a lacquer is a particularly suitable measure. Such a lacquer can additionally improve other properties, such as visual or haptic properties (to give colour, texture, glossy effects or various tactile experiences, visual effects (pearlescence, metallic, splattered paint, etc.) or use properties (protection against any of UV radiation, chemical attack and mechanical rupture). In one embodiment, the wet grip of the handle is improved by applying a thin layer of colorless lacquer with improved wet friction properties. This lacquer can provide a very nice silky texture and tactility. The lacquer can consist of a single or multi component grade and may or may not require a primer to improve adhesion to the substrate. Small particles or other additives can also be added to the lacquer to improve grip. The thickness of the lacquer can vary between 20 and 250 µm, and is most likely to be around 50 µm.

One suitable lacquer is a polyester based 2 component soft paint lacquer, such as Pehapol 2C soft paint P84004 by Peter Lacke or HARD 000033 by Nordwest Chemie. It is applied by spray painting. The volatile component evaporates.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

Reference numbers

| | |
|---|---|
| 10 | cartridge |
| 12 | lubrapad |
| 14 | blade housing |
| 16 | blades |
| 18 | guard |
| 20 | cap |
| 22 | lubrapad body |
| 26 | frame |
| 42 | rounded side portions (of the cartridge) |
| 50 | handle body |
| 51 | front surface portion or opposite end surface |
| 52 | rear surface portion or flat end surface |
| 53 | underneath surface portion |
| 54 | top surface portion |
| 55 | lateral surface portion |
| 56 | continuous side surface |
| 57 | handle attachment portion |
| 58 | handle body recess |
| 59 | handle connecting structure |
| 61 | cartridge connecting structure |
| 70 | outer layer |
| 80 | core layer |
| 81 | first core sublayer |
| 82 | second core sublayer |
| 83 | third core sublayer |
| 84 | forth core sublayer |
| 100 | safety razor or safety razor system |
| 161 | core material inlet |
| 162 | outer material inlet |
| 163 | rotating hub or core |
| 164 | moulding cavity |
| 165 | ejection chute |
| 200 | protective cover |

1. A safety razor handle with a chunky, non-elongate handle body comprising a core layermade of a plurality of sub-layers and an outer layerat least substantially covering the core layer.

2. The safety razor handle according to claim 1, wherein the plurality of sub-layers is created by injection moulding of one or more subsequent sub-layers onto a first sub-layer.

3. The safety razor handle according to claim 1, wherein the plurality of sub-layers is of a same material.

4. The safety razor handle according to claim 1, wherein the core layer is provided by between two and 6 sub-layers .

5. The safety razor handle according to claim 1, wherein a first sub-layer extends in a flat round shape from a handle attachment portion, any intermediate sub-layers extend in a flat round shape to one side or another of the first sub-layer and a final sublayer extends to at least partially surround the first sub-layer and the any intermediate sub-layers.

6. The safety razor handle according to claim 1, wherein an interlocking connection is provided between two of the plurality of sub-layers.

7. The safety razor handle according to claim 1, wherein a thickness of the plurality of sub-layers is at least substantially constant over a majority of their extent.

8. The safety razor handle according to claim 1, wherein the outer layeris of a softer material and the core layer is of one or more harder materials, and wherein both layers are translucent.

9. The safety razor handle according to claim 8, wherein borders between the plurality of sub-layers and a border between the core layer and the outer layer cannot be easily distinguished by a naked eye.

10. The safety razor handle according to claim 1, wherein the outer layerforms a complete covering over the core layer on an outer surface of the handle body.

11. The safety razor handle according to claim 1, wherein the core layeris thicker than the outer layer and wherein the outer layer is of substantially constant thickness at least over a majority of the core layer.

12. The safety razor handle according to claim 11, wherein the substantially constant thickness of the outer layer is between about 1 and 7 mm .

13. The safety razor handle according to claim 1, wherein the core layeris of an overall non-elongate, bulbous shape.

14. The safety razor handle according to claim 1, further comprising a handle connecting structurefor a cartridge and wherein the outer layerincludes an opening leading to a recess in the core layer housing the handle connecting structure.

15. The safety razor handle according to claim 1, further comprising a friction-enhancing finish on the outer layer, a friction-enhancing additive to the outer layer or a friction-enhancing surface coating on the outer layer.

16. The safety razor handle according to claim 1, wherein the handle body is bulbous in two orthogonal directions, between an end surfaceand a further end surfaceopposite to the end surface, the two opposite end surfaces being connected by a convex side surfacewhich widens towards a centre of the handle body.

17. The safety razor handle according to claim 16, wherein there is a single continuous side surfacebetween the two opposite end surfaces, wherein the further end surface is a front end surfacefacing in an opposite direction to a shaving direction in use and the end surfaceis a rear end surface facing in the shaving direction in use, and wherein a handle connecting structure is on the continuous side surface closer to the front end surface than to the rear end surface.

18. The safety razor handle according to claim 16, wherein one or both end surfaces are flat and the end surfaces are parallel.

19. The safety razor handle according to claim 1, wherein the handle bodyis in a form of a barrel shape, with a skewed barrel surface between two end surfaces, and wherein a largest diameter of the barrel shape is between a third and three times a length of a longitudinal axis of the barrel shape .

20. The safety razor handle according to claim 1, wherein the handle bodycomprises: an underneath surface portion comprising a handle connecting structure; a front surface and opposite rear surface portion; a top surface portion and side surface portions, one directed to either side of the handle body or cartridge width in use; wherein the top surface portion, underneath surface portion and side surface portions together form a continuous smooth surface which is a substantially cylindrical or substantially ellipsoid or substantially partially spherical surface; or whereina distance between the front surface portion and rear surface portion is between one third and three times a largest dimension of a largest cross section through the continuous smooth surface.

21. A safety razor comprising the safety razor handle according to claim 1, connected to a cartridge via a handle connecting structure.

22. A method of manufacturing a chunky, non-elongate handle body of a safety razor handle comprising sequentially moulding a plurality of sub-layers of a core layer and then moulding an outer layerat least substantially covering the core layer.

23. The method according to claim 22, wherein the handle body is injection moulded using an injection moulding apparatus with a rotating hub.

24. The method according to claim 23, wherein the rotating hub holdshandle bodies during moulding and rotates them to index between moulding positions in the injection moulding apparatus, each moulding position including a cavity which adds a sub-layer or layer to each handle body.

25. The method according to claim 24, wherein a finished handle body is ejected at an ejection position of the injection moulding apparatus.

26. The method according to claim 24, wherein material is injected into all the cavities at the same time.

27. The method according to claim 26, wherein the cavities are constructed so that each of the plurality of sub-layers and the outer layer takes a same amount of time to cool.
